(19) United States
(12) Patent Application Publication
(10) Pub. No.: US 2007/0152971 A1
(43) Pub. Date: Jul. 5, 2007

(54) Mouse pen and an optical structure thereof

(76) Inventor: Yuan-Jung Chang, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,713

(22) Filed: Dec. 30, 2005

(51) Int. Cl. G09G 5/08

(52) U.S. Cl. 345/166

(57) ABSTRACT

A mouse pen and an optical structure thereof are disclosed. The mouse pen includes a penholder and an optical structure. The optical structure is located in the penholder. The optical structure includes a fixing base, a lighting element, a photo sensor and a circuit board. The fixing base includes a first incline and a second incline. The first incline and the second incline forms an obtuse angle. The lighting element is located on the first incline. The photo sensor is located on the second incline. The circuit board is electrically connected with lighting element and the photo sensor. Thereby, the incident light emitted from the lighting element on the first incline is reflected from the surface passed over by the mouse pen, and is directly received by the photo sensor. A simplified optical structure is provided for reducing the cost and shrinking the volume of the optical structure.

### BACKGROUND OF THE INVENTION

1. Field of the Invention

The present invention relates to a mouse pen and an optical structure thereof. In particular, a mouse pen with a simplified optical structure that is cheap to manufacture and has a small volume. The mouse pen can also be applied to a variety of surfaces.

2. Description of the Related Art

Please refer to TW patent M258359. FIG. 1 shows a cross-sectional view of an optical structure of a mouse pen of the prior art. The mouse pen adopts a cursor control unit 8 with an optical-electrical type design. The cursor control unit 8 includes a lighting element 81 and a receiving element 82. There is a reflective slice 83 located between the lighting element 81 and the receiving element 82. The reflective slice 83 slides on a specified sliding board. The sliding board is divided into a plurality of mesh grids. When light emitting from the lighting element 81 shines on the blank of the sliding board and is reflected to the receiving element 82, the receiving element 82 is on and the control circuit obtains a low voltage. When the light shines on the mesh grid lines and is absorbed by the mesh grid lines, the receiving element 82 is off and outputs a high voltage. A computer processes the high/low voltage pulses in X and Y direction to obtain the displacement of the mouse pen.

Although the mouse pen with an optical structure of the prior art improves the drawbacks of the conventional mouse pen with a mechanical structure, its structure is complex. Because the reflection slice 83 must slide on the specified sliding board, the structure cannot be simplified. The cost and the volume of the mouse pen are increased.

Moreover, the lighting element 81 of the above mouse pen is a light emitting diode (LED). When the mouse pen is used on a smooth surface, the signal is not fluent. The optical image tracks transmitted to the computer can not exactly position the displacement of the mouse pen.

### SUMMARY OF THE INVENTION

One particular aspect of the present invention is to provide an optical structure of a mouse pen. In particular, an optical structure of a mouse pen with a simplified optical structure is used for reducing the cost of the optical structure and shrinking its size. The present invention enhances the detection function of the optical structure and increases the sensitivity of the optical structure.

Another particular aspect of the present invention is to provide a mouse pen. In particular, a mouse pen can be operated over a variety of surfaces.

The present invention provides a mouse pen and an optical structure thereof. The mouse pen includes a penholder and an optical structure. The optical structure is located in the interior of the penholder. The optical structure includes a fixing base having a first incline and a second incline. The first incline and the second incline form an obtuse angle. The optical structure also includes a lighting element located on the first incline, a photo sensor located on the second incline, a circuit board located on the second incline and electrically connected with lighting element and the photo sensor. The incident light emitted from the lighting element on the first incline is reflected from the surface passed over by the mouse pen, and is then directly received by the photo sensor on the second incline.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a cross-sectional view of an optical structure of a mouse pen of the prior art;

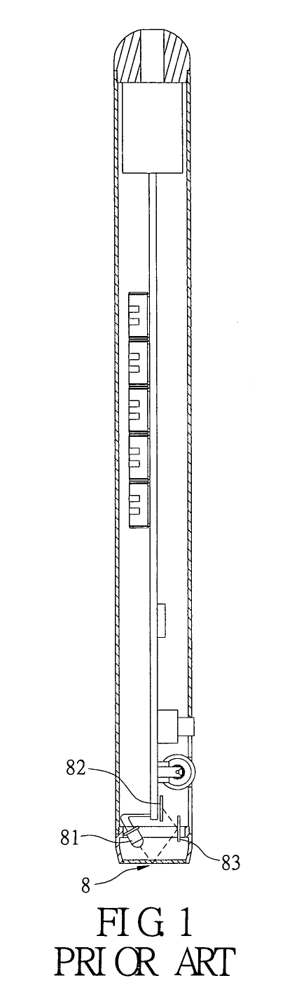

FIG. 2 is an exploded perspective view of the mouse pen of the present invention;

FIG. 3 is a perspective view of the appearance of the optical structure of the mouse pen of the present invention; and

FIG. 4 is a cross-sectional view of the optical structure of the mouse pen of the present invention.

### DETAILED DESCRIPTION OF THE PREFERRED EMBODIMENTS

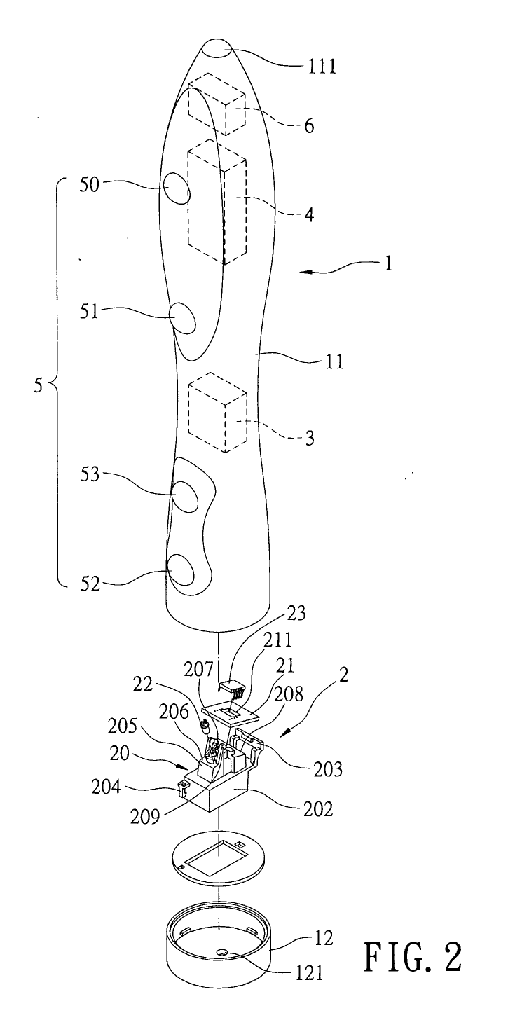

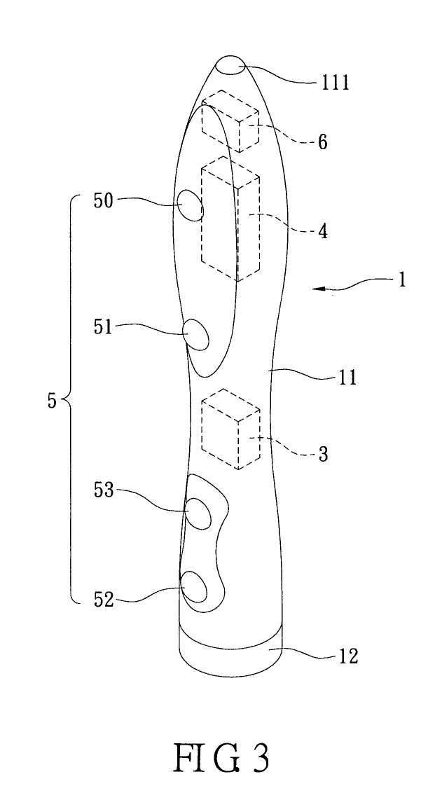

Please refer to FIGS. 2 to 4, which show an exploded perspective view, a perspective view of the appearance, and a cross-sectional view of the mouse pen of the present invention. The mouse pen includes a penholder 1, an optical structure 2, a wireless transition module 3, a rechargeable battery 4, a plurality of keys 5 and a laser-indicating device 6.

The penholder 1 includes a pen rod 11 and a pen cover 12. On the pen cover 12 there is a first opening 121. Via the first opening 121, the incident light 221 emitted from the lighting element 22 can shine on the plane 7. Then, the reflecting light 222 reflected from the plane 7 can reach the photo sensor 23.

The optical structure 2 is located in the interior of the penholder 1 and includes a fixing base 20, a lighting element 22, a photo sensor 23 and a circuit board 21.

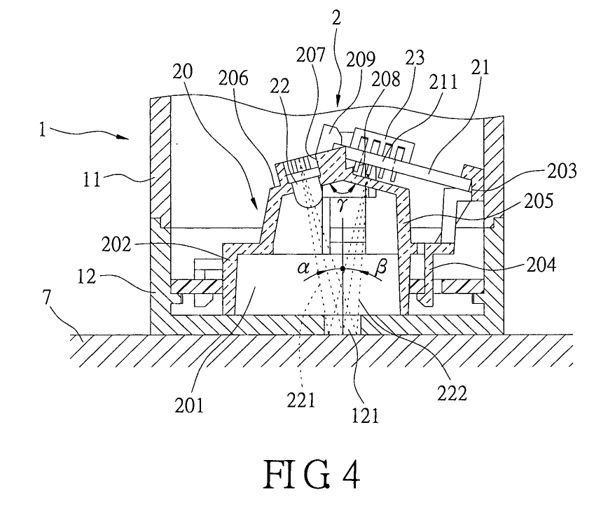

The fixing base 20 is integrated into one piece, and is installed on the pen cover 12 and is located above the first opening 121. The interior of the fixing base 20 forms a free cavity 201. The fixing base 20 includes a base 202 and a bulging part 205. The fixing base 20 has a first incline 206 and a second incline 208. The second incline 208 and the first incline 206 form an obtuse angle γ at the interior top of the bulging part 205. The obtuse angle γ is 150°±1° (as shown in FIG. 4). A first fixing angle 203 is extended upward from a side of the base 202. At the bottom of the opposite sides of the base 202 there is a wedged hook 204. The wedged hooks 204 is used for fastening the fixing base 20 onto the pen cover 12.

The bulging part 205 is protruded upward from the base 202. The first incline 206 and the second incline 208 are formed at the top of the bulging part 205. On the first incline 206 there is an embedded slot 207. The embedded slot 207 is vertically linked to the free cavity 201, and is used for embedding the lighting element 22. Therefore, the incident light 221 produced by the lighting element 22 shines on the plane 7 passed over by the mouse pen with an incident angle α of 15°±0.5° and generates a predetermined optical path. The predetermined incident angle is determined by the designer. A designer can choose an angle to reveal the surface characteristic of the plane 7. Therefore, light shining on the plane 7 reveals the surface characteristic of the plane 7 and the modulation of the light 222 reflected from the plane 7 that is modulated by the surface characteristic of the plane 7 becomes larger. Therefore, the sensibility of the mouse pen is enhanced. The second incline 208 is a pervious light surface and the pervious light surface is passed through the light reflected from the surface passed over by the mouse pen. On the top of the bulging part 205 there is at least one second fixing angle 209. The second fixing angle 209 and the first fixing angle 203 are individually fastened on the opposite ends of the circuit board 21 to make the circuit board 21 be parallel to the second incline 208. Thereby, the photo sensor 23 on the circuit board 21 directly receives the reflected light 222 reflected from the plane 7 passed over by the mouse pen.

The circuit board 21 is located on the second incline 208 for controlling the operation of the mouse pen, and is electrically connected with the lighting element 22 and the photo sensor 23. The circuit board 21 includes a second opening 211. The second opening 211 corresponds to the second incline 208. The incident light 221 emitting from the lighting element 22 on the first incline 208 is reflected from the plane 7 passed over by the mouse pen, and is then directly received by the photo sensor 23 on the second incline 208. The lighting element 22 and the photo sensor 23 form a symmetrical angle. Therefore, when the incident light 222 is modulated by the surface characteristic of the plane 7, the reflection light 222 passes through the first opening 121 and the free cavity 201, the second incline 208, and the second opening 211, and is then received by the photo sensor 23. As such, the incident light 221 emitting from the lighting element 22 is reflected from the plane 7 and is directly received by the photo sensor 23, the mouse pen does not need a light-guiding device to transmit light. Therefore, the design of the fixing base simplifies the design of the optical structure of the mouse pen. The cost and the volume of the optical structure are thereby reduced.

The lighting element 22 is located on the first incline 206 and is used for generating light. The lighting element 22 is a vertical cavity surface-emitting laser. The lighting element 22 is a solid laser. Taking a solid laser as a light source enhances the sensibility of the mouse pen on an object surface. Therefore, even though the mouse pen is moved over a smooth surface, the mouse pen still can transmit the exact displacement information to the computer. The mouse pen can obtain the exact object surface information, and solve the problem of the conventional mouse pen that cannot exactly position the displacement of the mouse pen on a smooth surface.

The photo sensor 23 is installed on the second incline 208 and is located above the second opening 211, and is used for detecting light emitting from the lighting element 22. The photo sensor 23 is a surface technology low power photo sensor. The reflection light 222 is transmitted to the photo sensor 23 via the second opening 211. Therefore, the photo sensor 23 obtains a series of signals. The photo sensor 23 further includes a photo reaction and control circuit (not shown in the figure.). Thereby, the photo sensor 23 can analyze the series of signals and decides the moving direction and the displacement of the mouse pen.

The plane for locating the circuit board 21 and the plane for locating the lighting element 22 form an obtuse angle. For an preferred embodiment, the obtuse angle is 150°±1°. Light emitting from the lighting element 22 directly passes through the free cavity 201 and the first opening 121 with an incident angle α (15°±0.5°), it is then reflected and passes through the first opening 121 and the free cavity 201 with a reflection angle β (15°±0.5°). Finally, the reflection light passes through second incline 208 and the second opening 211 and is transmitted to the photo sensor 23. Thereby, the optical structure of the mouse pen is simplified, and the cost and volume of the mouse pen are reduced.

The wireless transition module 3 is installed in the penholder 1. The wireless transition module 3 is a blue-tooth module and is used for transmitting data to the computer.

The rechargeable battery 4 is installed in the penholder 1. The rechargeable battery 4 is a lithium battery and is used for providing power to the mouse pen.

The plurality of the keys 5 is installed on the penholder 1. The plurality of keys 5 includes a communicating selection key 50, a laser-indicating key 51, a mouse left key 52 and a mouse right key 53.

The laser-indicating device 6 is installed at one end in the penholder 1. The one end is located at one end of the pen rod 11. At the one end there is a laser-indicating hole 111 for providing the laser light-indicating function.

The present invention has the following characteristics:

1. The design of the fixing base 20 simplifies the design of the optical structure 2 of the mouse pen. Therefore, the manufacturing cost of the optical structure 2 is reduced and the volume of the optical structure 2 is also lessened.

2. The lighting element 22 is a solid laser. Therefore, the sensibility of the mouse pen to the object surface is enhanced. Therefore, even though the mouse pen is moved over a smooth surface, the mouse pen still can transmit the exact displacement information to the computer. Due to the laser acting as a light source, the mouse pen can obtain exact object surface information.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An optical structure for a mouse pen, installed in the interior of the mouse pen, comprising:
a fixing base, having a first incline and a second incline, wherein the first incline and the second incline form an obtuse angle;
a lighting element, located on the first incline;
a photo sensor, located on the second incline; and
a circuit board, located on the second incline and electrically connected with the lighting element and the photo sensor; wherein incident light emitted from the lighting element on the first incline is reflected from the surface passed over by the mouse pen, and is then directly received by the photo sensor on the second incline.

2. The optical structure for a mouse pen as claimed in claim 1, wherein the lighting element and the photo sensor form a symmetrical angle.

3. The optical structure for a mouse pen as claimed in claim 1, wherein the fixing base is manufactured into one piece.

4. The optical structure for a mouse pen as claimed in claim 3, wherein the interior of the fixing base forms a free cavity, and the fixing base includes a base, a bulging part and at least one second fixing angle; wherein a first fixing angle is extended upward from one side of the base and the bulging part is protruded upward from the base; wherein the first incline and the second incline is formed at the top of the bulging part, on the first incline there is an embedded slot vertically linked with the free cavity, and the second incline is a pervious light surface; wherein the second fixing angle is located at the top of the bulging part, and the second fixing angle and the first fixing angle are individually fastened at two opposite ends of the circuit board.

5. The optical structure for a mouse pen as claimed in claim 4, wherein the circuit board includes a second opening, and the second opening corresponds to the second incline; wherein the photo sensor is located above the second opening, and the reflection light is transmitted to the photo sensor via the second opening.

6. The optical structure for a mouse pen as claimed in claim 4, wherein the bottom of the two sides of the base each has a wedged hook.

7. The optical structure for a mouse pen as claimed in claim 1, wherein the lighting element is a vertical cavity surface emitting laser.

8. The optical structure for a mouse pen as claimed in claim 1, wherein the lighting element is a surface technology low power photo sensor.

9. A mouse pen, comprising:
a penholder; and
an optical structure, installed in the interior of the penholder; wherein the optical structure comprises a fixing base having a first incline and a second incline and the first incline and the second incline form an obtuse angle, a lighting element located on the first incline, a photo sensor located on the second incline, and a circuit board located on the second incline and electrically connected with lighting element and the photo sensor; wherein incident light emitted from the lighting element on the first incline is reflected from the surface passed over by the mouse pen, and is then directly received by the photo sensor on the second incline.

10. The mouse pen as claimed in claim 9, wherein the penholder comprises a pen rod and a pen cover; wherein on the pen cover there is a first opening, and the fixing base is installed on the pen cover and is located above the first opening.

11. The mouse pen as claimed in claim 9, wherein the lighting element and the photo sensor form a symmetrical angle.

12. The mouse pen as claimed in claim 9, wherein the fixing base is manufactured into one piece.

13. The mouse pen as claimed in claim 12, wherein the interior of the fixing base forms a free cavity, and the fixing base includes a base, a bulging part and at least one second fixing angle; wherein a fist fixing angle is extended upward from one side of the base and the bulging part is protruded upward from the base; wherein the first incline and the second incline is formed at the top of the bulging part, on the first incline there is an embedded slot vertically linked with the free cavity, and the second incline is a pervious light surface; wherein the second fixing angle is located at the top of the bulging part, and the second fixing angle and the first fixing angle are individually fastened at two opposite ends of the circuit board.

14. The mouse pen as claimed in claim 13, wherein the circuit board includes a second opening, and the second opening corresponds to the second incline; wherein the photo sensor is located above the second opening, and the reflection light is transmitted to the photo sensor via the second opening.

15. The mouse pen as claimed in claim 13, wherein the bottom of the two sides of the base individually has a wedged hook.

16. The mouse pen as claimed in claim 9, wherein the lighting element is a vertical cavity surface emitting laser.

17. The mouse pen as claimed in claim 9, wherein the lighting element is a surface technology low power photo sensor.

18. The mouse pen as claimed in claim 9, further comprising a wireless transition module installed in the interior of the penholder.

19. The mouse pen as claimed in claim 18, wherein the wireless transition module is a blue-tooth module.

20. The mouse pen as claimed in claim 9, further comprising a rechargeable battery installed in the interior of the penholder.

21. The mouse pen as claimed in claim 20, wherein the rechargeable battery is a lithium battery.

22. The mouse pen as claimed in claim 9, further comprising a plurality of keys installed in the interior of the penholder; wherein the plurality of keys includes a communicating selection key, a laser-indicating key, a mouse left key and a mouse right key.

23. The mouse pen as claimed in claim 9, further comprising a laser-indicating device installed at one end in the penholder; wherein at the one end there is a laser-indicating hole.
